(19) United States
(12) Patent Application Publication
(10) Pub. No.: US 2010/0171318 A1
(43) Pub. Date: Jul. 8, 2010

(54) Magnetic drive for electrical generation

(76) Inventor: Robert Fredrick Rosselli, Mesa, AZ (US)

Correspondence Address: ROBERT F ROSSELLI, 7322 E DIAMOND AVE, MESA, AZ, 85208, US

(21) Appl. No.: 12/654,807

(22) Filed: Jan. 5, 2010

Related U.S. Application Data
(60) Provisional application No. 61/204,198, filed on Jan. 5, 2009.

(51) Int. Cl. H02K 7/18; H02K 21/02; H02N 11/00

(52) U.S. Cl. 290/1 R; 310/152; 415/916

(57) ABSTRACT

The magnetic drive for electrical generation is a magnetically driven mechanical device in which two opposing arrays of permanent magnets are set in electromagnetic fields arranged with their positive polarity ends facing each other and that are set at an angle relative to the exterior of an interior shaft with a gap between the two opposing arrays necessary to allow for the rotation of the arrays. The exterior magnetic array is fixed, while the interior magnetic array is connected to a rotating shaft. The exterior magnetic forces work to push against the interior magnets causing the interior magnetic array to rotate. The interior shaft is inserted through and connected to an electric generator, converting the mechanical rotation into electrical power.

Rotating magnetically driven mechanical machine, for use in converting mechanical energy into electrical energy for use in such devices as an alternator or generator particularly used for an automobile, appliance, home or industrial power source, or battery for purpose of generating power.

### BACKGROUND OF INVENTION

The Magnetic Drive for electrical generation is an invention that utilizes opposing magnetic forces to drive electrical generating systems such as generators and alternator type devices. Many inventions have utilized opposing magnetic forces, such as alternators or generators. The Magnetic Drive for electrical generation is unique in its configuration and arrangement of magnets that rely solely on the opposing magnetic forces and thus do not utilize external power sources.

### PRIOR ART

Although there is no real Prior Art or History of the use or design for use of a device such as the magnetic drive for electrical generation. The magnetic drive for electrical generation is a drive for the generation of electricity and as such a brief history of Prior Art and History of Electrical Generators seems appropriate. As Eric J. Erfourth described in his Patent of a Generator in U.S. Pat. No. 7,382,072 B2. “A generator is a device for converting mechanical energy into electrical energy and works by electromagnetic induction. A power source drives a coil winding, causing it to rotate between the poles of a permanent magnet or electromagnet. As the coil winding spins and cuts through the lines of force between the poles of the magnet, potential energy and electric current is generated and flows through the coil winding. The electric current that is generated may be either direct current (DC) or alternating current (AC). In AC generation, a sinusoidal output waveform is produced; no energy is induced as the coil winding rotates parallel to the magnetic flux lines, while maximum power is achieved when the coil winding is rotating tangential to the magnetic flux lines.

The first electric generators, or dynamos, were modeled and built in the 1830s. By the end of the nineteenth century, particularly Nikola Tesla was making significant advances in the field of electrical generation. In 1890, Tesla disclosed a pyromagneto-electric generator in U.S. Pat. No. 428,057, in which he recognized that the magnetic properties of iron and other magnetic substances may be compromised by raising the material to a certain temperature and restored by again lowering the temperature. Also in 1890, Tesla disclosed an electrical transformer or induction device in U.S. Pat. No. 433,702.

Alternating current generators in use at the time typically provided from one to three hundred alterations of current per second. It was soon recognized that higher rates of alteration would be an advantage. Producing higher rates of alteration with generator designs at the time, however, was difficult and resulted in decreased efficiency, primarily due to high magnetic leakage, and improved generator designs were sought. In U.S. Pat. No. 447,921, Tesla discloses a field-magnet core made up of two independent parts formed with grooves for the reception of one or more energizing coils. The energizing coils are completely surrounded by the iron core, except on one side, where there is a narrow opening between the polar faces of the core, and the polar faces of the core are formed with many projections or serrations. This field-magnet design produced less magnetic leakage but still did not operate at a desired level of efficiency.

In 1894, Tesla disclosed an electric generator in U.S. Pat. No. 511,916. This generator was capable of continued production of electric currents of constant period by imparting the movements of a piston to a core or coil in a magnetic field.

By the twentieth century, more reliable turbines were in use, capable of providing 50-60 Hertz power with 3000-3600 alternations of current per second. In U.S. Pat. No. 1,061,206, Tesla discloses a turbine that improves the use of fluids as motive agents by causing a propelling fluid to move in natural paths or stream lines of least resistance, avoiding losses due to sudden variations while the fluid is imparting energy. This method, when coupled with power generating equipment, provided a more efficient and reliable means of hydraulic power synthesis.

Another conventional generator example is the Detroit Edison generator. The Detroit Edison generator includes an outer extruded stationary permanent magnet with opposite magnetic poles forming an air gap at the center, with a number of windings rotated within the air gap to induce current in the rotating windings. As with other early generator designs, increased and improved efficiency was sought, often realized by increasing the length of the cylindrical generator.

Generator designs continued to advance in the twentieth century, where improvements made to the above-identified generator designs frequently focused on improving efficiency. U.S. Pat. No. 3,538,364, to Favereau, discloses a rotary electric machine comprising a fixed primary stator in the form of a pair of concentrically arranged inner and outer stator elements having magnetic poles and between which, in an air gap, the secondary cylindrical rotor having a winding thereon is mounted for rotation. The magnetic stator provides a 360-degree air gap between opposite magnetic poles in the inner and outer stator. This arrangement reduced the size of leakage fluxes and reduced the volume of the coils situated around the poles, permitting increases in the working induction in the cylindrical air gap.

More recently, improvements have recognized and addressed optimizing the waveshape of the generator output to maximize generator output and improve efficiency. In U.S. Pat. No. 5,650,680, Chula discloses a permanent magnet generator having a rotor including a plurality of permanent magnets generating an operative magnetic flux field, seeking to create an output voltage signal with reduced harmonic content.

Conventional generator designs typically include contacts, or “brushes,” that rotate relative to electrical contacts and provide a circuit for electricity to flow through. Brushes, however, require regular maintenance and replacement as they become worn. Additionally, the electrical resistance of the brushes and the mechanical frictional loss between the brushes and the contacts decrease generator efficiency. These drawbacks were recognized by Rakestraw et al. in U.S. Pat. No. 5,696,419, which discloses an electrical generator with a plurality of C-shaped stator members made of magnetically permeable material. A flat ring-shaped rotor defines a periphery, and a plurality of permanent magnets are positioned around the periphery. The rotor is positioned with the magnets of the rotor disposed in the gap defined by the stator members, so that when the rotor is rotated by a prime mover to move the magnets through the gap, an electrical current is induced in the stator windings.

Others have sought to improve generator efficiency by not only eliminating brushes but also improving per-magnet rotor excitation. In U.S. Pat. No. 6,462,449, Lucidarme et al. disclose a rotating electric machine where the rotor includes a magnetic field core provided with radial teeth, uniformly distributed at its periphery. Annular magnets are arranged on either side of the core axial ends and magnetic end flanges pressing the annular magnets against the core. Magnetic bars link the end between each of the bars and at least the side walls of the core radial teeth defining the spaces. The stator includes a magnetic core, excitation coils arranged on either side of the core, a stator coil wound on the core, and a magnetic ring in contact with the core and provided with radial rims cooperating with the axial rims of the rotor end flanges to form paths for the return flux.

While generator efficiencies have been increased through mechanical and electrical engineering methods as described above, there is still room for significant advancement and improvement. Relatively recent advancements in modern materials science have been applied to generator design and manufacture. For example, superconductive materials have been used in the construction of generator components. These materials provide a reduced resistance to the flow of electricity, and when used in generator components, superconductive materials have been shown to increase overall efficiency on the order of approximately 1%-3% in some applications, a relatively small gain that is quickly appreciated in large-scale generators.

An example of a trapped-field superconducting generator is disclosed in U.S. Pat. No. 5,325,002, to Rabinowitz et al. This motor/generator includes superconductive material in either the stator or the rotor and a magnetic field generator is included in the other of these two members. Induced fields in a torque-shield provide coupling between the stator and the rotor during the start-up phase of the motor/generator, and then a trapped field in the superconductor provides coupling between the stator and rotor thereafter.

U.S. Pat. No. 6,169,352, to Hull, discloses another example of a trapped-field superconducting motor generator. The motor generator includes a high temperature superconductor rotor and an internally disposed coil assembly. The motor generator superconductor rotor is constructed of a plurality of superconductor elements magnetized to produce a dipole field. The coil assembly can be either a conventional conductor or a high temperature superconductor. The superconductor rotor elements include a magnetization direction and c-axis for the crystals of the elements and which is oriented along the magnetization direction.”

The above-identified description is quoted from Eric J. Erfourth's description in his Patent of a Generator in U.S. Pat. No. 7,382,072 B2.

All of the above mentioned generators have one significant need. The need for a cost-effective, efficient external or internal power source that does not rely on combustion, nuclear, wind, water, and other finite or renewable energy resources to create the mechanical energy needed for the generator to convert into electrical power.

### SUMMARY OF INVENTION

The present invention meets the aforementioned needs by providing an external or internal mechanical power source to run a generator. The Magnetic Drive for electrical generation is a device that can be used to power any type of generator both AC (Alternating Current) and DC (Direct Current). It can be mounted externally to any type and size of generator or alternator type device, or built in to any standard configuration of generator or alternator type device. The Magnetic Drive for electrical generation utilizes opposing magnetic forces to create mechanical energy that can in turn be utilized to power a generator or alternator type device. Other patents have dealt with opposing magnetic forces. The Magnetic Drive for electrical generation is unique in the configuration and arrangement of said opposing magnetic forces, as well as the unique use of magnetism to create mechanical power.

The Magnetic Drive for electrical generation utilizes two sets of magnets arranged with their positive polarity ends facing each other. Said magnets are arrayed at angles relative to the external circumference of an interior shaft with the interior magnetic array mounted to said free motioned interior shaft, and the exterior magnetic array mounted to stabilized and permanent mounts. Each magnet is to be a permanent magnet in an electromagnetic field. Each magnet is to be made of the highest quality with special care being taken in the magnetization process so as to assure correct polarity.

The interior magnets are to be at least 2-3 times smaller than the exterior magnets allowing for greater magnetic force from the exterior magnets. Also the electromagnetic coil windings of the exterior magnets are to be at least be 2-3 times more in number than the windings of the interior magnets, also allowing for greater magnetic force in the exterior magnets. Thus the power of the magnetic force in the exterior magnets will be at least 2-3 times that of the interior magnets allowing the exterior magnets to push against and freely turn the interior magnetic array and shaft, thus creating mechanical energy that can be utilized to power any type and size of generator or alternator type device.

The Magnetic drive for electrical generation can be utilized to power generators for use in supplying electrical energy to motors that can in turn run electric vehicles. Further the Magnetic drive for electrical generation can be used to power generators for the production of electricity to homes and industry. A Magnetic drive for electrical generation that is large enough could power all the electrical needs of the average household or business. Larger ones could be developed to power dynamos that supply power to entire electrical grids or for industrial uses. Also a smaller Magnetic drive for electrical generation can be built to power small generators for use in supplying electricity to individual appliances and machinery, relieving the need for electricity to power them and thus expanding their usefulness to include places and situations were electricity is not readily available. Lastly, with micro and nano technologies a Magnetic drive for electrical generation and generator could be built to sizes ranging from power packs to batteries, so that any power pack or battery operated product could be run without need for standard or rechargeable power packs or batteries.

All generators, motors and alternator parts, as well as all wiring and harnesses must be compatible in their input/output as well as type (i.e. AC alternating current/DC direct current), and be sufficient to work in combination. For instance an electric motor that required 120 volts and 450 amps would thus require a generator capable of achieving a convertible output sufficient to run the motor. Additionally any converters electrical wiring and harnesses as well as all applicable parts would need to be similarly compatible.

Careful attention should be taken to ensure magnetic shielding from all other parts and systems. (i.e. automotive electronic systems, including but not limited to climate control devices, audio systems, lighting systems, etc, also appliance systems, and housing and industrial systems, etc. Magnetic fields are dangerous to people with pacemakers, etc. Careful attention should be taken to ensure magnetic shielding from humans and pets.

### BRIEF DESCRIPTION OF DRAWINGS

The present invention may be more readily understood in consideration of the following descriptions of the accompanying drawings.

FIG. 1 is a representative drawing of the exterior and interior magnetic arrays, and their position in relation to each other and the interior array shaft. Also shown is the polarity of the magnetic arrays and the gapping between the exterior magnetic array and the interior magnetic array.

FIG. 2 is a representative drawing of the opposing magnetic fields and their relative size differences.

FIG. 3 is a representative drawing of the opposing magnetic fields and their positions in relation to the interior array shaft.

FIG. 4 is a cross sectional view of the actual interior and exterior permanent magnets with their magnetic centerlines shown.

FIG. 5 is a perspective view of an exterior and interior permanent magnet.

FIG. 6 is a perspective view of an exterior and interior permanent magnet showing the electromagnetic windings of each.

FIG. 7 is a cross sectional view of the exterior magnetic array tray that houses the exterior electromagnetic permanent magnets. Also shown is the housing channel utilized to house the coil wiring and harness.

FIG. 8 is a perspective view that shows an individual exterior magnetic array tray slot that houses the exterior electromagnetic permanent magnet, and depicts the wiring holes for the positive and negative sides of the electromagnetic coil for said exterior magnet.

FIG. 9 is a cross sectional view of the interior magnetic array tray that houses the interior electromagnetic permanent magnets. Also shown is the housing channel utilized to house the coil wiring and harness, as well as the central hub and interior shaft.

FIG. 10 is a perspective view that shows an individual interior magnetic array tray slot that houses the interior electromagnetic permanent magnet, and depicts the wiring holes for the positive and negative sides of the electromagnetic coil for said interior magnet.

FIG. 11 is a perspective view of the exterior magnetic array tray housing channel with its associated wiring harnesses.

FIG. 12 is a perspective view of the interior magnetic array tray housing channel with its associated wiring harnesses.

FIG. 13 is a cross sectional view of the center hub, showing the interior shaft

FIG. 14 is a cross sectional view of the interior shaft. It depicts the relationship and position on the interior tray slots and wiring holes, as well as the central hub. It also depicts the alternator type device utilized by the interior array to supply power to the interior coils at each of the interior electromagnetic permanent magnets.

FIG. 15 is a cross sectional view of the Magnetic drive for electrical generation, depicting the Magnetic drive for electrical generation Engager/Disengager that is utilized to separate and block the interior and exterior magnetic fields. It is employed to stop and start the Magnetic drive for electrical generation. The Engager/Disengager is shown in the disengaged position thus the Magnetic drive for electrical generation would be at rest.

FIG. 16 is a cross sectional view of the gap between the exterior array tray and the interior array tray and shows the Engager/Disengager is in the Engaged position thus the Magnetic drive for electrical generation would be in motion.

FIG. 17 is a cross sectional view of the gap between the exterior array tray and the interior array tray and shows the Engager/Disengager is in the disengaged position thus the Magnetic drive for electrical generation would be at rest.

FIG. 18 is a cross sectional view of the Engager/Disengager screw motor that allows the Engager/Disengager to raise and lower the shielding into the gap between the exterior array tray and the interior array tray.

FIG. 19 is a representative drawing of a configuration that could be utilized to power an electrical vehicle. It depicts the interior and exterior array trays, the center hub with its interior shaft, as well as the alternator type device utilized by the interior array to supply power to the interior coils it also depicts the Magnetic drive for electrical generation Engager/Disengager that is utilized to start and stop the Magnetic drive for electrical generation. Also depicted is a generator, which is utilized to power the exterior array tray as well as to power an electric motor setup. Also depicted are a battery source for use with the Engager/Disengager, and a transmission-drive shaft assembly.

FIG. 20 is a representative drawing of a configuration that could be utilized to power an electrical generator for the production of electricity to homes and industry. It depicts the interior and exterior array trays, the center hub with its interior shaft, as well as the alternator type device utilized by the interior array to supply power to the interior coils it also depicts the Magnetic drive for electrical generation Engager/Disengager that is utilized to start and stop the Magnetic drive for electrical generation. Also depicted is a generator, which is utilized to power the exterior array tray as well as to supply electrical power for housing and business needs. Also depicted is a battery source for use with the Engager/Disengager.

FIG. 21 is a representative drawing of a configuration that could be utilized to power a small electrical generator for the production of electricity to individual appliances and machinery. It depicts the interior and exterior array trays, the center hub with its interior shaft, as well as the alternator type device utilized by the interior array to supply power to the interior coils it also depicts the Magnetic drive for electrical generation Engager/Disengager that is utilized to start and stop the Magnetic drive for electrical generation. Also depicted is a generator, which is utilized to power the exterior array tray as well as to supply electrical power to individual appliances and machinery. Also depicted is a battery source for use with the Engager/Disengager.

FIG. 22 is a representative drawing of a configuration that could be utilized to power a micro or nano electrical generator for the production of electricity to power individual power pack or battery operated devices. It depicts the interior and exterior array trays, the center hub with its interior shaft, as well as the alternator type device utilized by the interior array to supply power to the interior coils, the exterior array tray and its coils, as well as to supply electricity to power individual power pack or battery operated devices. Also depicted is the Magnetic drive for electrical generation Engager/Disengager tab that is utilized to start and stop the Magnetic drive for electrical generation.

FIG. 23 is a representative drawing that shows a micro or nano hair width magnet wrapped with micro or nano fine wires to produce a micro or nano technology electromagnetic permanent magnet for use in the arrays in FIG. 22 & FIG. 23.

### DETAILED DESCRIPTION OF DRAWINGS

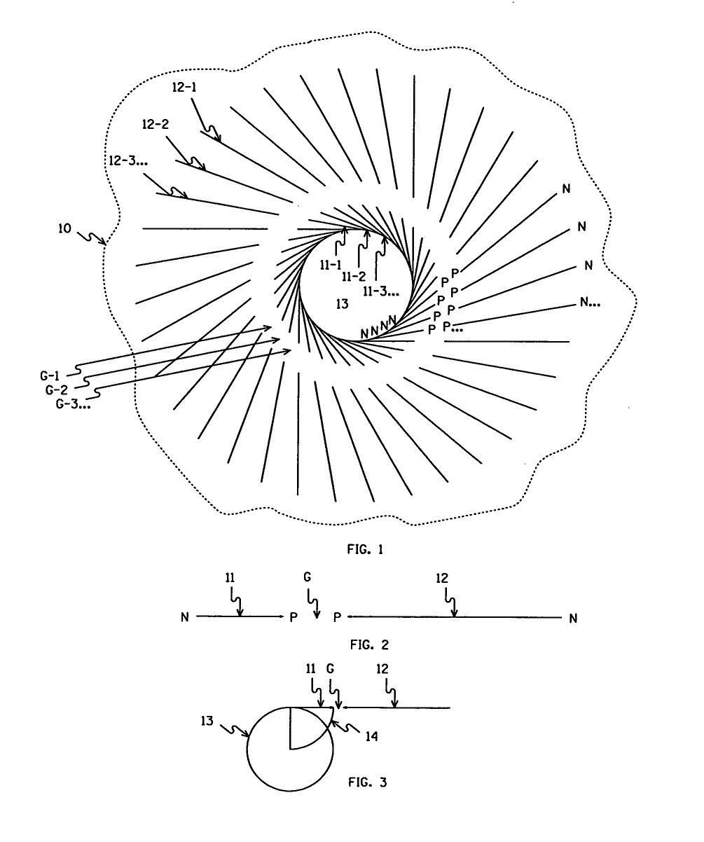

The present invention can be more readily understood by reference to FIGS. 1-23 and the allowing descriptions. While the present invention is not necessarily limited to such applications, the invention will be better appreciated using a discussion of example embodiments in such a specific context.

While the present invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

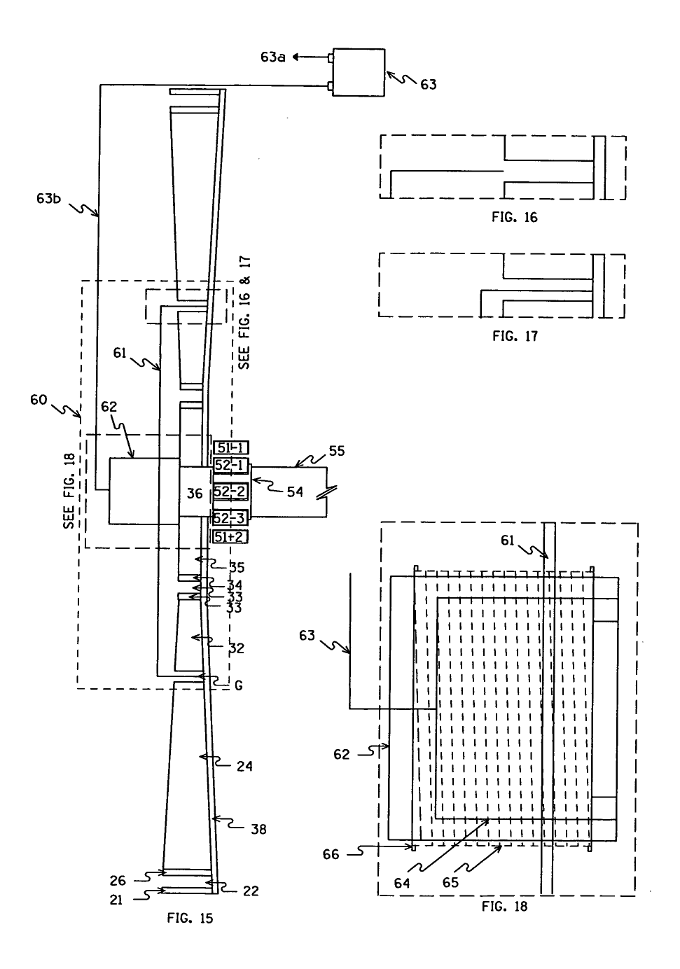

FIG. 1 is a representative drawing of the exterior 12 and interior 11 magnetic array lines, and their position in relation to each other and the interior array shaft 13. Also shown is the polarity P (Positive) & N (Negative) of the magnetic arrays 11 & 12 and the gapping G between the exterior magnetic array 12 and the interior magnetic array 11. FIG. 1 shows the exterior magnetic array line 12 pushing against the interior magnetic array line 11, causing the interior magnetic array 11 to rotate freely around the interior array shaft 13. The gapping G between the exterior 12 and interior 11 magnetic arrays should be no greater than to allow for the free turning of the interior magnetic array 11 and the engaging of the Magnetic drive for electrical generation Engager/Disengager See FIG. 15 (60), which is to be made of non-electrically conductive, non-magnetic, insulated materials.

FIG. 2 is a representative drawing of the opposing magnetic fields P & N and their relative size differences. The Magnetic drive for electrical generation utilizes magnets arranged with their positive polarity ends P facing each other. The interior magnetic field 11 to be at least 2-3 times smaller than the exterior magnetic field 12 allowing for greater magnetic force from the exterior magnets 12. Thus the power of the magnetic force in the exterior magnetic field 12 will be at least 2-3 times that of the interior magnetic field 11.

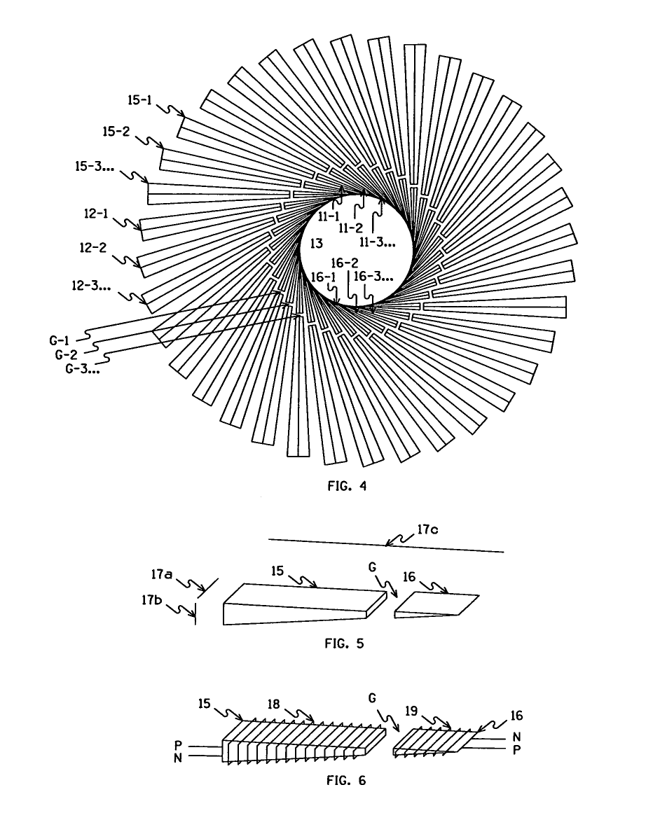

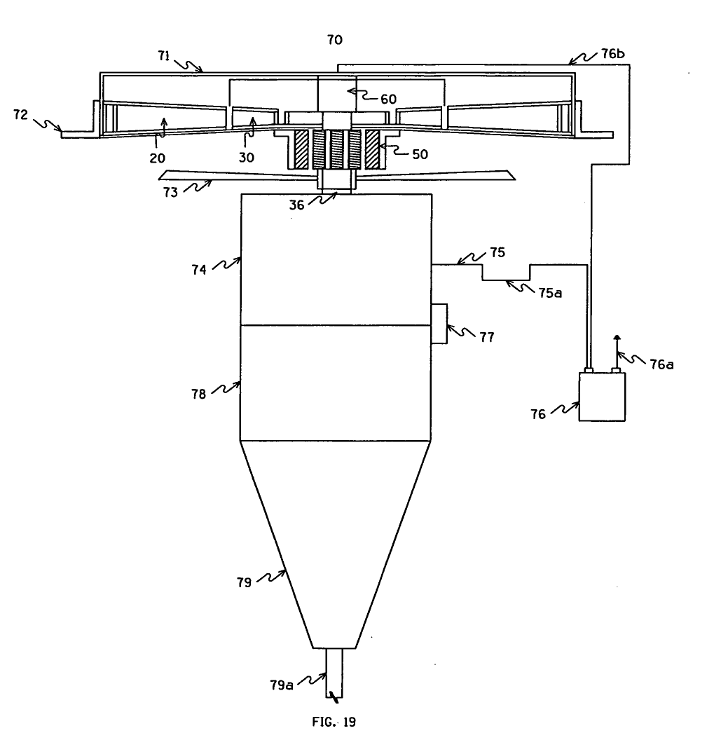

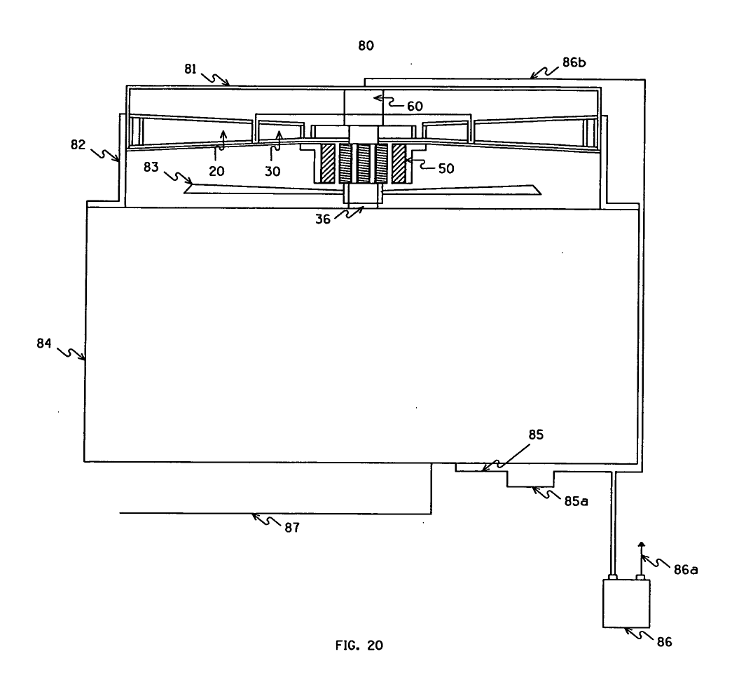

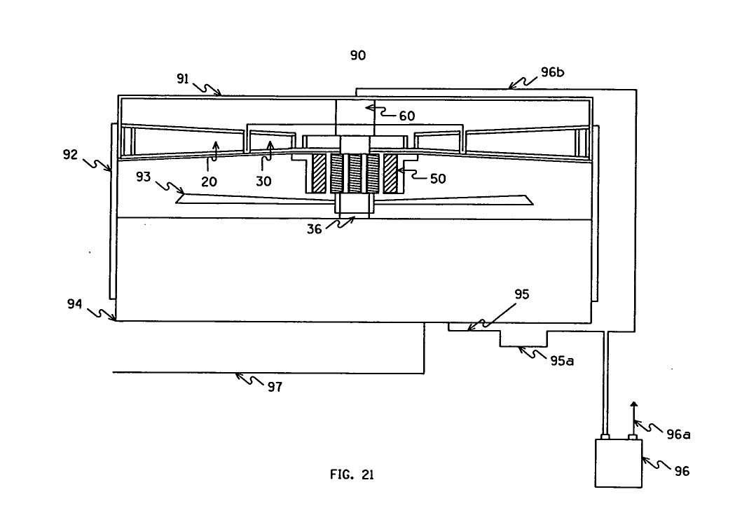

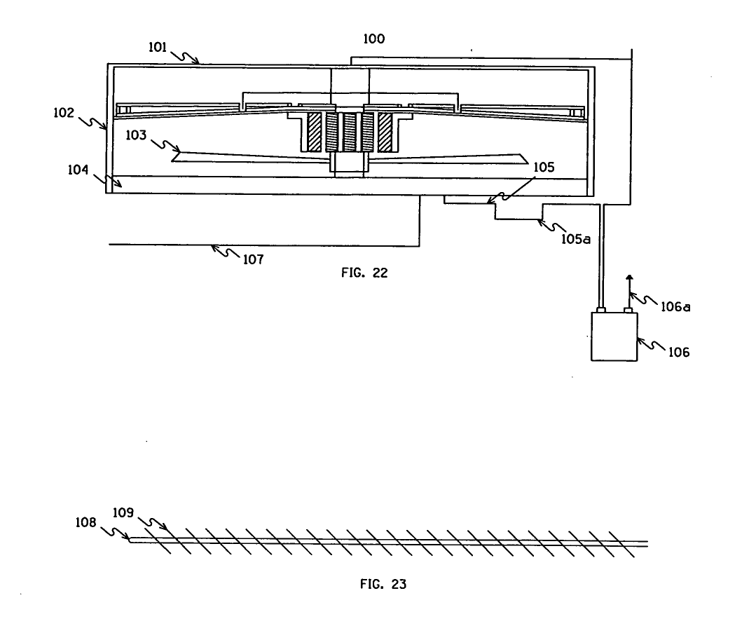

FIG. 3 is a representative drawing of the opposing magnetic fields P and their positions in relation to the interior array shaft 13. The magnets are arrayed at angles 14 relative to the external circumference of an interior shaft 13 with the interior magnetic array 11 mounted to said free motioned interior shaft 13, and the exterior magnetic array 12 mounted to stabilized and permanent mounts See FIG. 19 (72), FIG. 20 (82), FIG. 21 (92) or FIG. 22 (102).

FIG. 4 is a cross sectional view of the actual interior 16 and exterior 15 permanent magnets with their magnetic centerlines 11 & 12 shown. The Magnetic drive for electrical generation utilizes two sets of magnets 15 & 16 that are arrayed at an angle See FIG. 3 (14) relative to the external circumference of an interior shaft 13 with the interior magnetic array 16 mounted to said free motioned interior shaft 13, and the exterior magnetic array 15 mounted to stabilized and permanent mounts See FIG. 19 (72), FIG. 20 (82), FIG. 21 (92) or FIG. 22 (102), which are to be made of non-electrically conductive, non-magnetic, insulated materials. Each magnet is to be a permanent magnet in an electromagnetic field. The interior magnets 16 are to be at least 2-3 times smaller than the exterior magnets 15 allowing for greater magnetic force from the exterior magnets 15. Also the electromagnetic coil windings See FIG. 6 (18) of the exterior magnets 15 are to be at least be 2-3 times more in number than the windings See FIG. 6 (19) of the interior magnets 16, also allowing for greater magnetic force in the exterior magnets 15. Thus the power of the magnetic force in the exterior magnets 15 will be at least 2-3 times that of the interior magnets 16. The gapping G between the exterior 15 and interior 16 magnetic arrays should be no greater than to allow for the free turning of the interior magnetic array 16 and the engaging of the Magnetic drive for electrical generation Engager/Disengager See FIG. 15 (60), which is to be made of non-electrically conductive, non-magnetic, insulated materials.

FIG. 5 is a perspective view of an exterior 15 and interior 16 permanent magnets. The width 17b of each magnet is solely dependent on the circumference of the interior shaft, as well as the size of Magnetic drive for electrical generation and power needed. The depth 17a of each magnet is dependent on the size of Magnetic drive for electrical generation and power needed. The length 17c of each magnet is dependent on the size of Magnetic drive for electrical generation and power needed. The gapping G between the exterior 15 and interior 16 magnetic arrays should be no greater than to allow for the free turning of the interior magnetic array 16 and the engaging of the Magnetic drive for electrical generation Engager/Disengager See FIG. 15 (60), which is to be made of non-electrically conductive, non-magnetic, insulated materials.

FIG. 6 is a perspective view of an exterior 15 and interior 16 permanent magnets showing the electromagnetic windings 18 & 19 of each. The electromagnetic coil windings 18 of the exterior magnets 15 are to be at least be 2-3 times more in number than the windings 19 of the interior magnets 16, allowing for greater magnetic force in the exterior magnets 15. Additionally FIG. 6 shows the Positive P & Negative N leads from the electromagnetic coil windings 18 of the exterior magnets 15 and the coil windings 19 of the interior magnets 16.

FIG. 7 is a cross sectional view of the exterior magnetic array tray 20, which is to be made of non-electrically conductive, non-magnetic, insulated materials, which houses the exterior electromagnetic permanent magnets See FIG. 4 (15). The exterior magnetic array See FIG. 4 (12) will consist of a plurality of permanent magnets See FIG. 4 (15) in electromagnetic fields See FIG. 6 (18). Each magnet See FIG. 4 (15) with its windings See FIG. 6 (18) shall fit tightly into each tray slot 23. The walls 24 of each tray slot 23 shall be doubly insulated with non-electrically conductive, non-magnetic, insulated materials. The leads P & N from each magnet See FIG. 4 (15) shall go through its designated hole 25 in the shielding wall 26 and into the wiring harness trough 22 where it will be bundled with all other wires associated with a section of the tray 20 and thus exit the tray through the exterior shielding 21, which is to be made of non-electrically conductive, non-magnetic, insulated materials, and through the wiring harness ports 27.

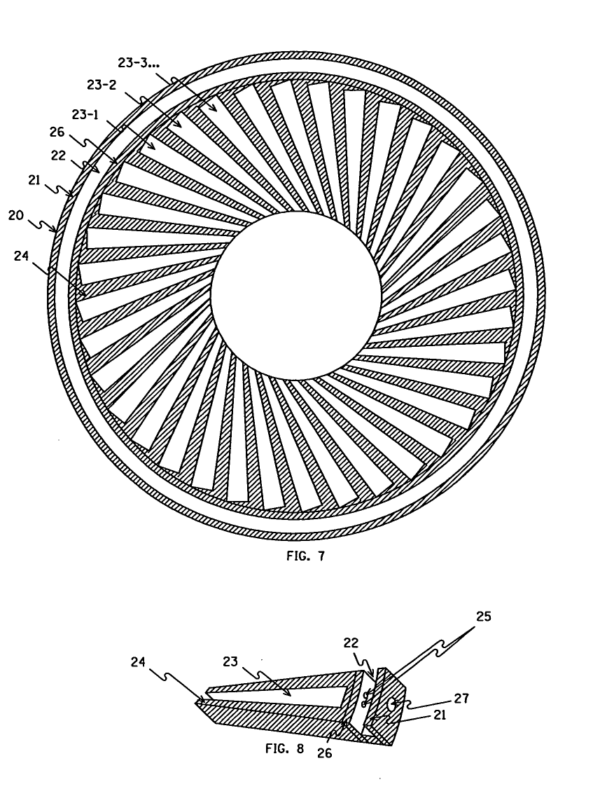

FIG. 8 is a perspective view that shows an individual exterior magnetic array tray slot 23 that houses the exterior electromagnetic permanent magnet See FIGS. 4 (15), and depicts the wiring holes 25 for the positive P and negative N sides of the electromagnetic coil See FIG. 6 (18) for said exterior magnet See FIG. 4 (15). Each magnet See FIG. 4 (15) with its windings See FIG. 6 (18) shall fit tightly into each tray slot 23. The walls 24 of each tray slot 23 shall be doubly insulated with non-electrically conductive, non-magnetic, insulated materials. The leads P & N from each magnet See FIG. 4 (15) shall go through its designated hole 25 in the shielding wall 26 and into the wiring harness trough 22 where it will be bundled with all other wires associated with a section of the tray 20 and thus exit the tray through the exterior shielding 21, which is to be made of non-electrically conductive, non-magnetic, insulated materials, and through the wiring harness ports 27.

FIG. 9 is a cross sectional view of the interior magnetic array tray 30, which is to be made of non-electrically conductive, non-magnetic, insulated materials, which houses the interior electromagnetic permanent magnets See FIG. 4 (16). The interior magnetic array See FIG. 4 (11) will consist of a plurality of permanent magnets See FIG. 4 (16) in electromagnetic fields See FIG. 6 (19). Each magnet See FIG. 4 (16) with its windings See FIG. 6 (19) shall fit tightly into each tray slot 31. The walls 32 of each tray slot 31 shall be doubly insulated with non-electrically conductive, non-magnetic, insulated materials. The leads P & N from each magnet See FIG. 4 (16) shall go through its designated hole 37 in the shielding wall 33 and into the wiring harness trough 34 where it will be bundled with all other wires associated with a section of the tray 30 and thus exit the tray through the interior shielding 38, which is to be made of non-electrically conductive, non-magnetic, insulated materials, and through the wiring harness ports 39. The interior hub 36 is additionally shielded with non-electrically conductive, non-magnetic, insulated materials 35.

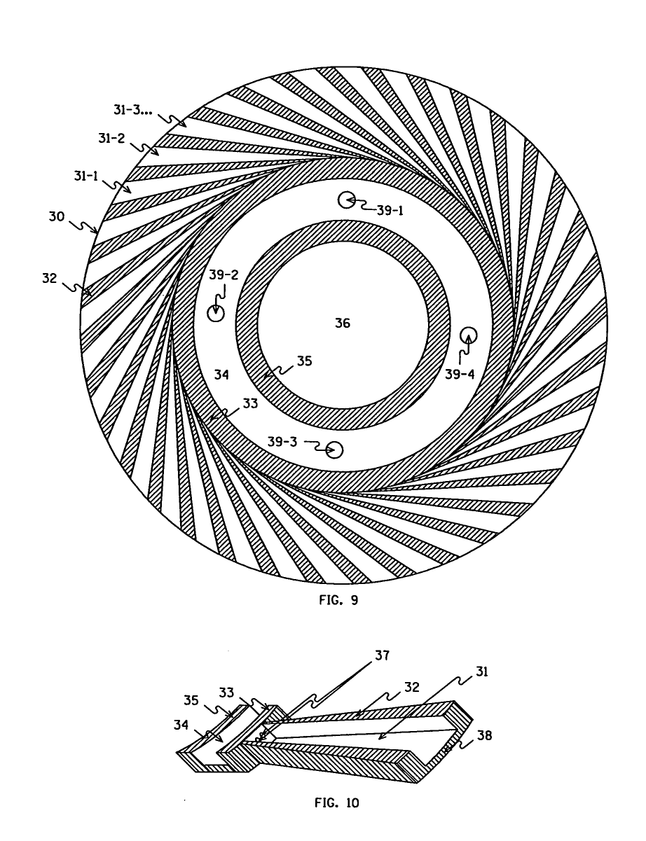

FIG. 10 is a perspective view that shows an individual interior magnetic array tray slot 31 which is to be made of non-electrically conductive, non-magnetic, insulated materials, which houses the interior electromagnetic permanent magnets See FIG. 4 (16). The interior magnetic array See FIG. 4 (11) will consist of a plurality of permanent magnets See FIG. 4 (16) in electromagnetic fields See FIG. 6 (19). Each magnet See FIG. 4 (16) with its windings See FIG. 6 (19) shall fit tightly into each tray slot 31. The walls 32 of each tray slot 31 shall be doubly insulated with non-electrically conductive, non-magnetic, insulated materials. The leads P & N from each magnet See FIG. 4 (16) shall go through its designated hole 37 in the shielding wall 33 and into the wiring harness trough 34 where it will be bundled with all other wires associated with a section of the tray 30 and thus exit the tray through the interior shielding 38, which is to be made of non-electrically conductive, non-magnetic, insulated materials, and through the wiring harness ports 39. The interior hub 36 is additionally shielded with non-electrically conductive, non-magnetic, insulated materials 35.

FIG. 11 is a perspective view of the exterior magnetic array tray housing channel 40 with its associated wiring harnesses 43. The positive P wires 41 leading from each of the exterior magnets See FIG. 4 (15) are bundled into their respective sectional harness 43, which then exit the exterior tray See FIG. 7 (20) through the wiring ports See FIG. 8 (27) along cables 44. The negative N wires 42 leading from each of the exterior magnets See FIG. 4 (15) are bundled into their respective sectional harness 43, which then exit the exterior tray 20 through the wiring ports See FIG. 8 (27) along cables 44.

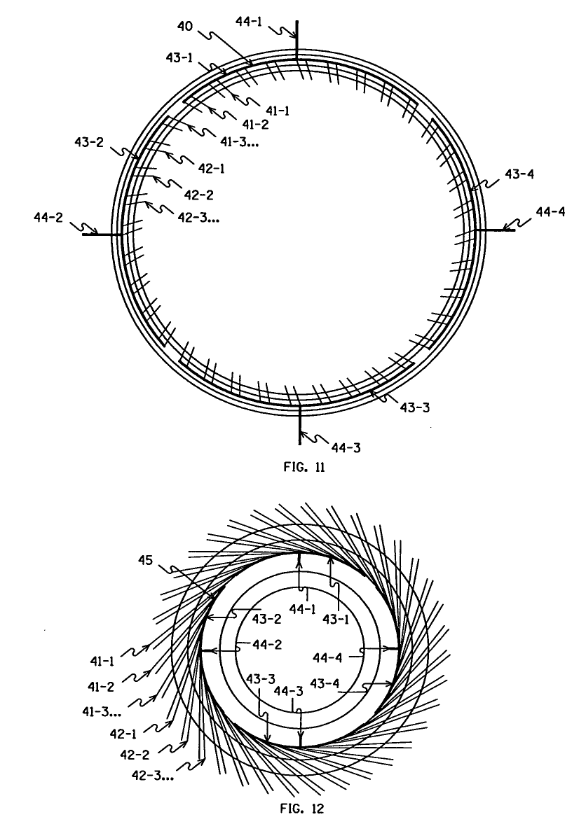

FIG. 12 is a perspective view of the interior magnetic array tray housing channel 45 with its associated wiring harnesses 43. The positive P wires 41 leading from each of the interior magnets See FIG. 4 (16) are bundled into their respective sectional harness 43, which then exit the interior tray See FIG. 9 (30) through the wiring ports See FIG. 9 (39) along cables 44. The negative N wires 41 leading from each of the interior magnets See FIG. 4 (16) are bundled into their respective sectional harness 43, which then exit the interior tray See FIG. 9 (30) through the wiring ports See FIG. 9 (39) along cables 44.

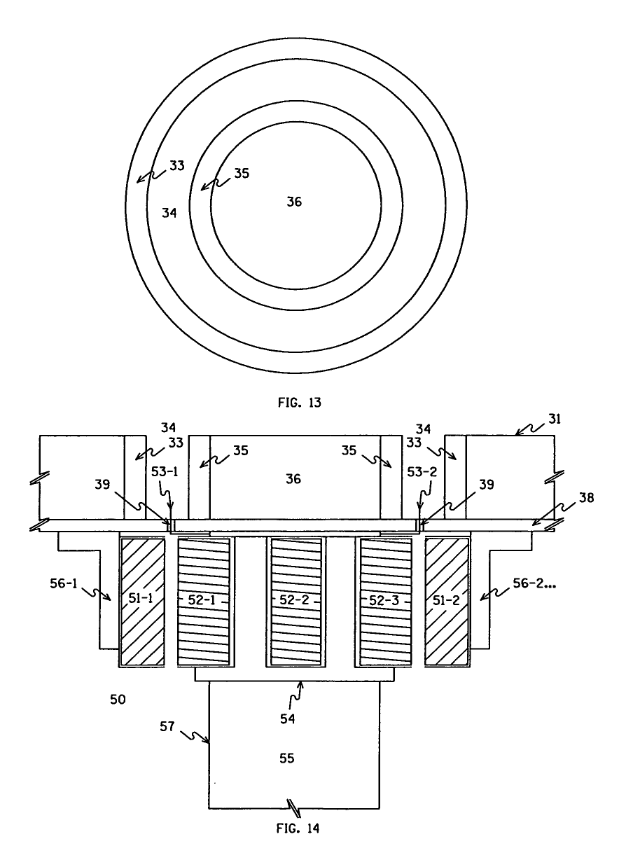

FIG. 13 is a cross sectional view of the center hub 36, showing the interior shaft, the housing channel 34 utilized to house the wiring harness See FIG. 12 (43) for the interior magnets See FIG. 4 (16), and the interior 33 and exterior 35 shielding walls.

FIG. 14 is a perspective view of the interior shaft 36, depicting the relationship and position on the interior tray slots 31 and wiring holes 39, as well as the central hub 36 and the alternator type device 50 utilized by the interior array See FIG. 4 (16) to supply power to the interior coils See FIG. 6 (19). The alternator type device 50 contains stators or conductors wound in coils on iron rods 52 and motors or coiled magnets 51 to create an AC electrical current that will be generated and sent through the rectifier 54 which converts it to DC current which then is fed to the interior magnetic array See FIG. 4 (16) to power up the electromagnetic fields See FIG. 4 (11) in the interior coils See FIG. 6 (19). Power runs to each of the interior electromagnetic permanent magnets See FIG. 4 (16) through the housing channel 33 utilized to house the wiring harness See FIG. 12 (43) for the interior magnets See FIG. 4 (16). The wiring holes See FIG. 10 (37) for the positive P and negative N sides of the electromagnetic coil See FIG. 6 (19) for said interior magnet See FIG. 4 (16) are bundled into wiring harnesses See FIG. 12 (43) that run though the wiring holes 39 to the power out connectors of the alternator type device 50. Thus as the interior shaft 36 turns, it rotates the stators 52, which rotate past the motors 51, that are mounted to permanent mounts 56, that are attached to the bottom 38 of the interior array tray, creating an AC flow of electricity which is then fed into the rectifier 54, which converts the AC charge to a DC flow of current, which then travels along the transfer wires 53, through the wiring holes 39, that send it along the wiring harnesses See FIG. 12 (43), and along the leads See FIGS. 12 (41) & (42) and into the coilings See FIG. 6 (19) of the interior magnetic array See FIG. 4 (16).

FIG. 15 is a cross sectional view of the Magnetic drive for electrical generation Engager/Disengager 60 that is utilized to separate and block the interior See FIG. 4 (16) and exterior See FIG. 4 (15) magnetic fields. It is employed to stop and start the Magnetic drive for electrical generation. The Engager/Disengager 60 is shown in the disengaged position thus the Magnetic drive for electrical generation would be at rest. Power from an external power supply or battery 63 which is properly grounded 63a, runs along line 63b to screw motor at 62 which then withdraws the cover and engager plate 61 from the gapping G in the channel between interior tray See FIG. 9 (30) and exterior tray See FIG. 7 (20) and thus starts the magnetic drive for electrical generation.

FIG. 16 is a cross sectional view of the gap G between the exterior array tray See FIG. 7 (20) and the interior array tray See FIG. 9 (30) and shows the Engager/Disengager See FIG. 15 (60) and it's separation and shielding tray See FIG. 15 (61) is in the disengaged position thus the Magnetic drive for electrical generation would be in motion.

FIG. 17 is a cross sectional view of the gap G between the exterior array tray See FIG. 7 (20) and the interior array tray See FIG. 9 (30) and shows the Engager/Disengager See FIG. 15 (60) and it's separation and shielding tray See FIG. 15 (61) is in the engaged position thus the Magnetic drive for electrical generation would be at rest.

FIG. 18 is a cross sectional view of the Engager/Disengager screw motor 62 that allows the Engager/Disengager 60 to raise and lower the shielding 61 into the gap G between the exterior array tray 15 and the interior array tray 16. Although a screw motor 62 is shown and detailed, any of a variety of mechanical motors can be utilized to operate the Engager/Disengager 60. Power from a power source 63 travels along the supply line 63 to the screw motor 62 allowing the motor 64 to turn the screw device 65, to raise or lower the shielding and separation platform 61. Stops 66 are provided to restrict the limits of the motor in terms of allowed distance of retraction or engagement.

FIG. 19 is a perspective view of a configuration that could be utilized to power an electrical vehicle 70. The configuration utilizes the Magnetic drive for electrical generation which is mounted to a generator 74 with secured mounts 72 and is encased in non-electrically conductive, non-magnetic, insulated materials 71. The Engager/Disengager 50 is started and the magnets in the exterior array 20 are allowed to push against the magnets in the interior array 30 causing the central hub 36 to turn. This then turns the alternator type device 50 which increases the power to the interior array 30. The central hub turns a shaft in the generator 74 which then creates electricity which is rectified and transmitted to the electric motor 78 which is utilized to turn the shaft of the transmission 79 which successively turns the driveshaft thus running the vehicle. Additional power from the generator is routed through wiring 75 into a regulator/converter 75a into the battery 76 which is properly grounded 76a thus recharging the battery. From there the additional power is sent along wires 76b back into the exterior array 20 to increase its power. A fan 73 is connected to the central hub 36 to cool all the related parts and thus extend the life of the devices.

FIG. 20 is a perspective view of a configuration that could be utilized to supply power to a home or business 80. The configuration utilizes the Magnetic drive for electrical generation which is mounted to a generator 84 with secured mounts 82 and is encased in non-electrically conductive, non-magnetic, insulated materials 81. The Engager/Disengager 50 is started and the magnets in the exterior array 20 are allowed to push against the magnets in the interior array 30 causing the central hub 36 to turn. This then turns the alternator type device 50 which increases the power to the interior array 30. The central hub turns a shaft in the generator 84 which then creates electricity which is rectified and transmitted through a power line 87 into a structure for use in powering the structure. Additional power from the generator is routed through wiring 85 into a regulator/converter 85a into the battery 86 which is properly grounded 86a thus recharging the battery. From there the additional power is sent along wires 86b back into the exterior array 20 to increase its power. A fan 83 is connected to the central hub 36 to cool all the related parts and thus extend the life of the devices.

FIG. 21 is a perspective view of a configuration that could be utilized to supply power to an appliance or piece of machinery 90. The configuration utilizes the Magnetic drive for electrical generation which is mounted to a generator 94 with secured mounts 92 and is encased in non-electrically conductive, non-magnetic, insulated materials 91. The Engager /Disengager 50 is started and the magnets in the exterior array 20 are allowed to push against the magnets in the interior array 30 causing the central hub 36 to turn. This then turns the alternator type device 50 which increases the power to the interior array 30. The central hub turns a shaft in the generator 94 which then creates electricity which is rectified and transmitted through a power line 97 into an appliance or piece of machinery. Additional power from the generator is routed through wiring 95 into a regulator/converter 95a into the battery 96 which is properly grounded 96a thus recharging the battery. From there the additional power is sent along wires 96b back into the exterior array 20 to increase its power. A fan 93 is connected to the central hub 36 to cool all the related parts and thus extend the life of the devices.

FIG. 22 is a perspective view of a configuration that could be utilized to supply power to an appliance or piece of machinery 100. The configuration utilizes the Magnetic drive for electrical generation which is mounted to a generator 104 with secured mounts 102 and is encased in non-electrically conductive, non-magnetic, insulated materials 101. The Engager/Disengager 50 is started and the magnets in the exterior array 20 are allowed to push against the magnets in the interior array 30 causing the central hub 36 to turn. This then turns the alternator type device 50 which increases the power to the interior array 30. The central hub 36 turns a shaft in the generator 104 which then creates electricity which is rectified and transmitted through a power line 107 into an appliance or piece of machinery. Additional power from the generator is routed through wiring 105 into a regulator/converter 105a into the battery 106 which is properly grounded 106a thus recharging the battery. From there the additional power is sent along wires 106b back into the exterior array 20 to increase its power. A fan 103 is connected to the central hub 36 to cool all the related parts and thus extend the life of the devices.

FIG. 23 is a representative drawing that shows a micro or nano hair width magnet 108 wrapped with micro or nano fine wires 109 to produce a micro or nano technology electromagnetic permanent magnet for use in the arrays.

Field of Classification Search 310/156.09; 310/152; 310/153; 310/156.01; 310/156.08; 310/156.12; 310/156.26; 310/156.32; 310/156.339; 310/156.38; 310/156.39; 310/156.41; 310/156.43; 310/156.44; 310/156.45; 310/156.46; 310/156.47; 310/156.48; 310/156.49; 310/156.53; 310/156.55; 310/156.56; 310/156.57; 310/156.65; 310/156.73; 310/158; 310/166; 310/168; 310/178; 310/181; 310/46; 310/114; 310/23; 310/24; 310/34; 310/35; 310/261; 318/138; 360/99.7; 360/99.8; 360/98.07; 360/99.04; 384/10; 652 384/107; 384/120; 384/131; 384/132; 505/166; 505/876

### REFERENCES CITED

U.S. Patented Documents

| | | |
|---|---|---|
| 428,057 A | May 1890 | Tesla |
| 433,702 A | August 1890 | Tesla |
| 447,921 A | March 1891 | Tesla |
| 511,916 A | January 1894 | Tesla |
| 1,061,206 A | May 1913 | Tesla |
| 2,806,159 A | September 1957 | Sheldon |
| 3,493,800 A | February 1970 | Barrett |
| 3,538,364 A | November 1970 | Favereau |
| 4,827,171 A | May 1989 | Bertram et al. |
| 5,117,142 A | May 1992 | Von Zweygbergk |
| 5,227,702 A | July 1993 | Nahirney |
| 5,325,002 A | June 1994 | Rabinowitz et al. |
| 5,350,958 A | September 1994 | Ohnishi |
| 5,554,903 A | September 1996 | Takara |
| 5,608,281 A | March 1997 | Gerling et al. |
| 5,625,241 A | April 1997 | Ewing et al. |
| 5,650,680 A | July 1997 | Chula |
| 5,696,419 A | December 1997 | Rakestraw et al. |
| 5,719,458 A | February 1998 | Kawai |
| 5,841,211 A | November 1998 | Boyes |
| 5,892,311 A | April 1999 | Hayasaka |
| 5,917,261 A | June 1999 | Kawai |
| 5,925,958 A | July 1999 | Piere |
| 5,955,809 A | September 1999 | Shah |
| 6,002,193 A | December 1999 | Canini et al. |
| 6,037,696 A | March 2000 | Sromin et al. |
| 6,097,118 A | August 2000 | Hull |
| 6,100,620 A | August 2000 | Radovsky |
| 6,127,764 A | October 2000 | Torok |
| 6,147,415 A | November 2000 | Fukada |
| 6,169,352 B1 | January 2001 | Hull |
| 6,172,438 B1 | January 2001 | Sakamoto |
| 6,462,449 B1 | October 2002 | Lucidarme et al. |
| 7,382,072 B2 | June 2008 | Erfourth |

What is claimed is:

1) A magnetic drive for electrical generation, which is a rotating magnetically driven mechanical machine that utilizes opposing magnetic forces to create mechanical energy or motion. The magnetic drive for electrical generation is unique in its configuration and arrangement of magnets that rely solely on the opposing magnetic forces to create mechanical power.

2) A magnetic drive for electrical generation, which utilizes magnets, arranged in opposing arrays, with their positive polarity ends facing each other, with each magnet a permanent magnet in an electromagnetic field. The magnets are arrayed at angles relative to the external circumference of an interior shaft with the interior magnetic array mounted to said free motioned interior shaft, and the exterior magnetic array mounted to stabilized and permanent mounts.

3) The interior magnetic array of claim 2 and as such its electromagnetic windings and magnetic fields are at least 2-3 times smaller than the exterior magnetic fields allowing for greater magnetic force from the exterior magnets. Thus the power of the magnetic force in the exterior magnetic field is at least 2-3 times greater than that of the interior magnetic field. The power of the magnetic force in the exterior magnets will thus push against and freely turn the interior magnetic array and in so doing thereby rotate the interior hub and shaft, thus creating mechanical energy, that in turn can be used to turn a shaft in a generator and produce electricity.

4) The width, length and depth of each magnet in claim 2 is solely dependent on the circumference of the interior shaft, as well as the size of the magnetic drive for electrical generation and the power needed to be generated.

5) The magnetic arrays in claim 2 are arranged in trays, which are to be made of non-electrically conductive, non-magnetic, insulated materials, and each tray shall have slots to house each magnet and its electromagnetic windings. Each tray shall also have troughs to house the wiring harness and applicable parts.

6) A gap exists between exterior and interior magnetic fields of claim 1. This gap will be no greater than to allow for the free turning of the interior magnetic array and the non-electrically conductive, non-magnetic, insulated Engager/Disengager separation and shielding tray.

7) An Engager/Disengager, which is to be made of non-electrically conductive, non-magnetic, insulated materials, and which will be utilized to start and stop the device with a separation and shielding tray.

8) The entire magnetic drive for electrical generation device and its components are properly shielded with non-electrically conductive, non-magnetic, insulated materials. Careful attention should be taken to ensure magnetic shielding from all other parts and systems. (i.e. automotive electronic systems, including but not limited to climate control devices, audio systems, lighting systems, etc, also appliance systems, and housing and industrial systems, etc. Magnetic fields are dangerous to people with pacemakers, etc. Careful attention should be taken to ensure magnetic shielding from humans and pets. All generators, motors and alternator parts, as well as all wiring and harnesses must be compatible in their input/output as well as type (i.e. AC alternating current/DC direct current), and be sufficient to work in combination. For instance an electric motor that required 120 volts and 450 amps would thus require a generator capable of achieving a convertible output sufficient to run the motor. Additionally any converters electrical wiring and harnesses as well as all applicable parts would need to be similarly compatible.

9) A magnetic drive for electrical generation can be produced for all types and models of current generators, turbines, etc. A magnetic drive for electrical generation can be utilized to power generators for use in supplying electrical energy to motors that can in turn run electric vehicles. Further the Magnetic drive for electrical generation can be used to power generators for the production of electricity to homes and industry. A Magnetic drive for electrical generation that is large enough could power all the electrical needs of the average household or business. Larger ones could be developed to power dynamos that supply power to entire electrical grids or for industrial uses. Also a smaller Magnetic drive for electrical generation can be built to power small generators for use in supplying electricity to individual appliances and machinery, relieving the need for electricity to power them and thus expanding their usefulness to include places and situations were electricity is not readily available. Lastly, with micro and nano technologies a Magnetic drive for electrical generation and generator could be built to sizes ranging from power packs to batteries, so that any power pack or battery operated product could be run without need for standard or rechargeable power packs or batteries.
